(19) United States
(12) Patent Application Publication
(10) Pub. No.: US 2003/0003969 A1
(43) Pub. Date: Jan. 2, 2003

(54) Cellular telephone headset

(76) Inventors: Eric Tong, Los Angeles, CA (US); Christopher Maddox, Redondo Beach, CA (US); Darren Saravis, Long Beach, CA (US); John Duval, Long Beach, CA (US); Michael Wick, Long Beach, CA (US); Mitchell Suckle, Long Beach, CA (US); Joie Puckett, Long Beach, CA (US)

Correspondence Address: BRYAN CAVE LLP, 245 Park Avenue, New York, NY, 10167, US

(21) Appl. No.: 09/896,658

(22) Filed: Jun. 29, 2001

(51) Int. Cl. H04M 1/00

(52) U.S. Cl. 455/568; 455/569

(57) ABSTRACT

A headset adapted for use with a cellular telephone comprises an earphone shaped to fit in the ear of a user, an earphone arm extending from the earphone to an earphone arm pivot end, a support protrusion extending from the earphone arm pivot end to rest under the ear of the user when wearing the headset, a telescoping arm extending from a microphone to a microphone arm pivot end, the microphone arm pivot end pivotally connected to the earphone arm, the telescoping arm having an arcuate shape.

### BACKGROUND

A headset may be used in conjunction with a telephone device for several reasons. With a headset, the user is relieved of the need to hold the phone and thus retains his or her “handsfree” to perform other functions. Headsets also function to position the earphone and microphone portions of a telephone close to the user's head to provide for clearer reception and transmission of audio signals with less interference from background noise. Because headsets may be worn for a long period of time, comfort is a desirable feature.

Headsets are particularly useful with cellular phones because a cellular phone user is more likely to be engaged in other activities during a telephone conversation and is more likely to be in a location having a high level of background noise. With a mobile device such a cellular phone there is an increased need for compactness and portability. Headsets designed for stationary use, for example while sitting at a desk, are often too bulky for use as a cellular phone accessory.

When operating a car, hands-free communication is also important for safety reasons. In a conventional hands-free system for use in an automobile, a speaker system is permanently installed into the automobile so that the user may have a telephone conversation without holding a mobile phone. Such installations are costly, however. Furthermore, the user's ability to use the system is limited to the time the user remains in the automobile in which the system was installed. The user is unable to utilize the installed speaker system when he or she is outside of the vehicle. If the user changes vehicles, the user must have the system installed again in the new vehicle.

One type of conventional headset utilizes an earphone that is inserted into the ear of a user and a microphone that may be clipped on a location near the user's mouth. An example of a headset of this type is disclosed in U.S. Pat. No. 5,850,439. This type of headset design requires a suitable location to clip the microphone. Often the user lacks such a location and is forced to clip the microphone at a location distant from the mouth, thereby decreasing the transmission quality. Furthermore, the plug-into-the-ear type of earphone used with this type of headset tends to easily pop out of the ear of the user when the cord leading to the earphone is inadvertently tugged.

Another type of conventional headset incorporates a headband to secure the earphone to the user's ear. In addition, a microphone boom extends from an earpiece enclosing the earphone towards the mouth of the user. An example of a headset of this type is disclosed in U.S. Pat. No. 6,154,539. Because the microphone boom is attached to the earpiece, there is no need to clip the microphone to the user. The headband used with this type of headset, however, adds an undesirable bulk to the accessory, making this design less desirable for use with a portable device such as a cellular phone. Another problem with this type of headset is that the microphone boom may reach past the user's mouth when worn by some users and fall short of the mouth when worn by other users, thus decreasing the quality of the audio transmission.

An adjustable headset incorporating a microphone boom without a headband is disclosed in U.S. Pat. No. 6,097,827. The headset described therein has a microphone boom that is adjustable by sliding and rotation. However, the microphone boom of the described headset is of a fixed length that may still reach too far forward for some users and fall short on others.

### SUMMARY

The present invention is directed to an apparatus that provides an adjustable, compact, hands-free headset adapted for use with a cellular telephone. A headset having features of the present invention comprises an earphone shaped to fit into the ear of a user. An earphone arm extends from the earphone to an earphone arm pivot end. A support protrusion extends from the pivot end of the earphone arm to provide additional support to the headset against the head of the user. A telescoping arm extends between a microphone and a microphone arm pivot end, where the microphone arm pivot end is pivotally connected to the earphone arm. The user may pivot the telescoping arm in relation to the earphone arm and may also retract or extend the telescoping arm to adjust the position of the microphone with respect to the mouth of the user.

### DRAWINGS

These and other features, aspects, and advantages of the present invention will become better understood with regard to the following description, appended claims, and accompanying drawings where:

FIG. 1 shows a drawing of an embodiment of the invention in perspective view.

FIG. 2A is a side view of the earphone arm of FIG. 1.

FIG. 2B is an illustration of a typical ear of a user.

FIG. 2C is a cross-sectional view the support protrusion of FIG. 2A.

FIGS. 3A through 3E show the telescoping arm of FIG. 1 at varying extensions. FIG. 3A shows the telescoping arm in a fully extended position, FIG. 3E shows the telescoping arm in a fully retracted position, and FIGS. 3B, 3C and 3D show the telescoping arm at varying intermediate positions.

FIGS. 3F and 3G each show an example pivoting position of the telescoping arm of FIG. 1 in relation to the earphone arm of FIG. 1.

FIG. 4 shows the remote control unit of FIG. 1.

FIGS. 5A and 5B show a frontal view and a side view of an embodiment of an ear hook for the headset of FIG. 1, respectively.

FIG. 5C shows the ear hook of FIGS. 5A and 5B as attached to the headset of FIG. 1

FIG. 6A shows an embodiment of an eyeglass attachment for the headset of FIG. 1.

FIG. 6B shows the eyeglass attachment of FIG. 6A as attached to the headset of FIG. 1.

FIG. 7 shows a side view of the headset of FIG. 1 in a folded position.

FIG. 8 shows a cross sectional view illustrating the internal wiring of the headset of FIG. 1.

FIG. 9 shows a perspective view the headset of FIG. 1 being worn by a typical user.

### DESCRIPTION

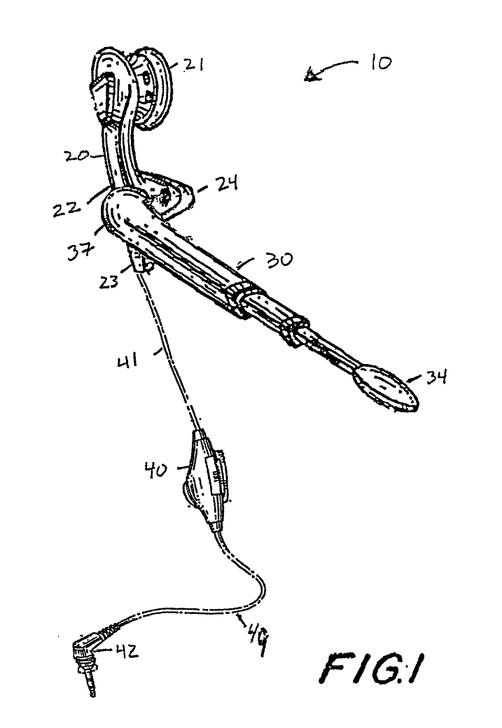

FIG. 1 shows a projection view of a cellular phone headset 10 in accordance with a preferred embodiment of the invention. An earphone arm 20 extends from an earphone 21 to an earphone arm pivot end 22. A telescoping arm 30 extends between a microphone 34 and a microphone arm pivot end 37. The microphone arm pivot end 37 is pivotally connected to the earphone arm 20. A support protrusion 24 extends from the earphone arm pivot end 22. Communication wires 41 lead from the communications lead 23 of the earphone arm pivot end 22 to a conventional remote control unit 40 and second communication wires 49 lead from the remote control unit 40 to the conventional plug connector 42 which connects to a jack of a conventional cellular telephone (not shown).

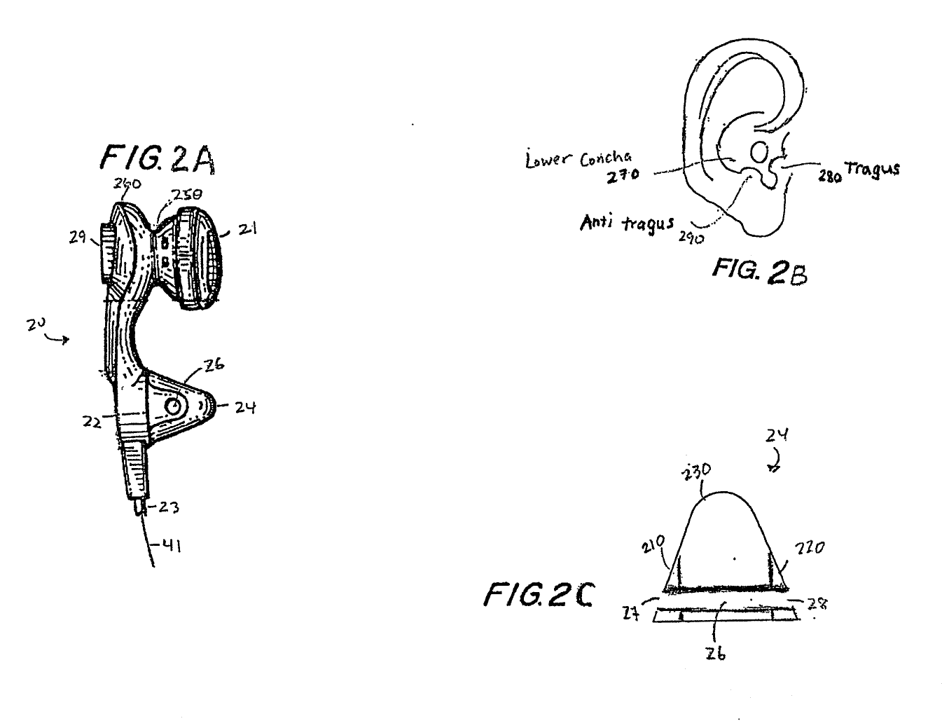

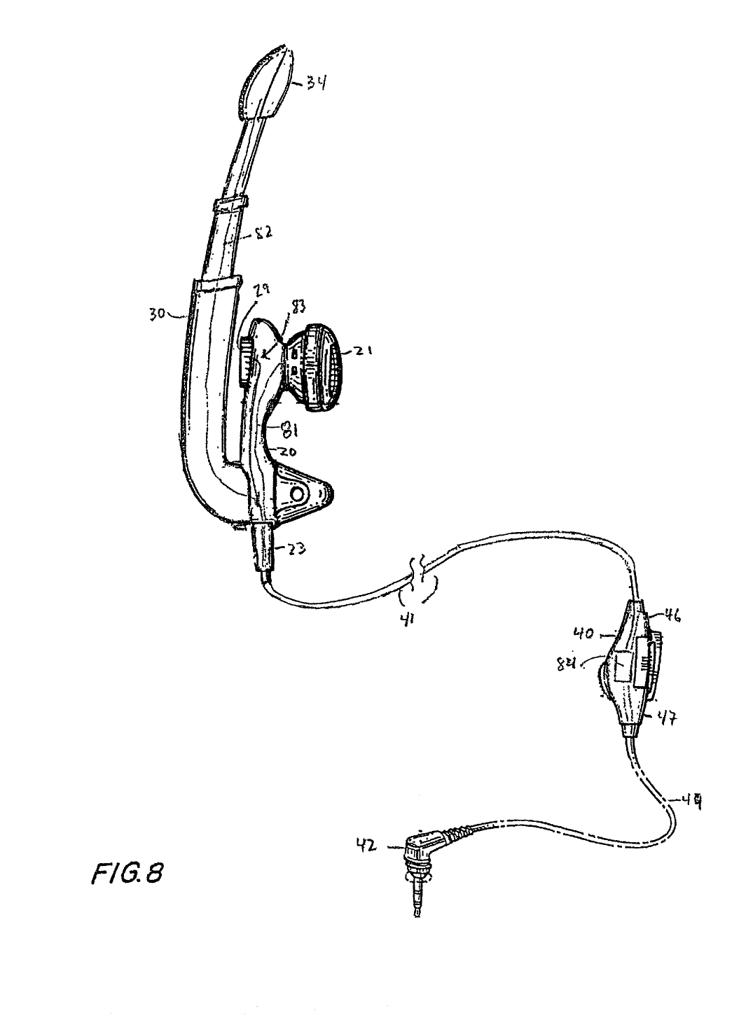

FIG. 2A shows a side view of the earphone arm 20 of FIG. 1. The earphone arm 20 extends from an earphone 21 to the earphone arm pivot end 22. A push button 29 is embedded in the earphone arm 20 at a location easily accessed by the user. A support protrusion 24 extends from the earphone arm pivot end 22 to provide an additional point of support for the headset 10 when worn against the head of the user. A communications lead 23 is located at the pivot end 22 of the earphone arm 20 through which the communication wires 41 enter and leave the earphone arm 20. The internal wiring of the earphone arm 20 is described below in connection with FIG. 8.

The earphone 21 of FIG. 2A is adapted or shaped to fit alternatively into either the left or right ear of the user. The earphone arm 20 has a neck portion 250 located behind the earphone 21 and an extension or shoulder 260 located behind the neck portion 250. Referring to FIG. 2B, the earphone 21 of FIG. 2A is intended to be positioned in the lower concha 270 of the ear of a user with the neck portion 250 of the earphone 21 fitting over the tragus 280 and anti-tragus 290 portions of the ear. The shoulder 260 of FIG. 2A contributes to the stability of the headset 10 in position against the head of the user.

A conventional button 29 such as a push button is embedded in the earphone arm 20. When the headset 10 is attached to a cellular telephone that supports conventional OneTouch™ functionality the button 29 may be used to answer an incoming call, end a call in progress, or activate voice dialing.

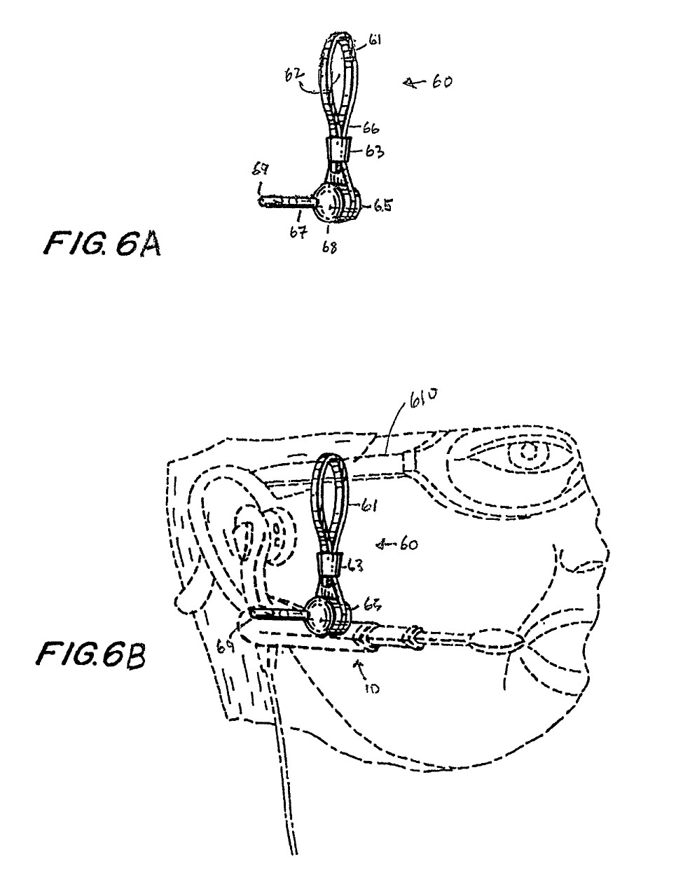

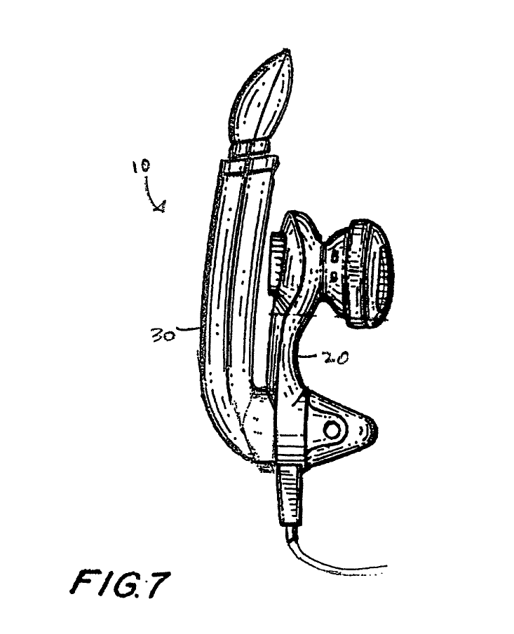

FIG. 2C shows a cross sectional view of the support protrusion 24 of FIG. 2A. The support protrusion 24 is comprised of retention members 210 and 220 that extend from earphone arm 20. Retention members 210 and 220 frame a flexible portion 230 of the support protrusion 24. A hole 26 passes through the first retention member 210, the flexible portion 230, and the second retention member 220. The hole has a first side opening 27 and a second side opening 28. The side openings 27 and 28 are shaped to receive attachments such as the eyeglass attachment 60 of FIG. 6. The flexible portion 230 is composed of a flexible material that has a relatively high friction quotient. The friction of the flexible portion 230 against the head of a user contributes to the stability of the headset 10 in position against the head of the user. In addition, the frictional quality of the material of the flexible portion 230 of the hole 26 contributes to the frictional fit of an attachment secured within the flexible portion 230 of the hole 26.

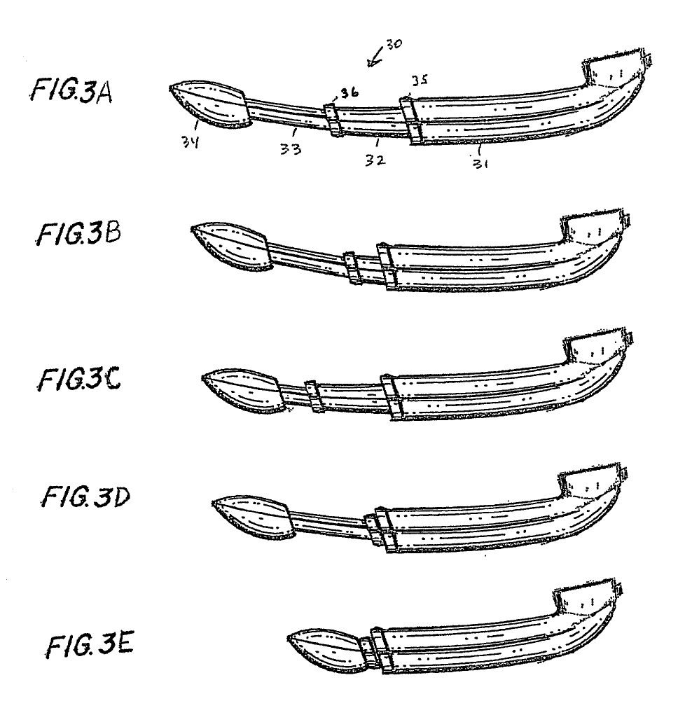

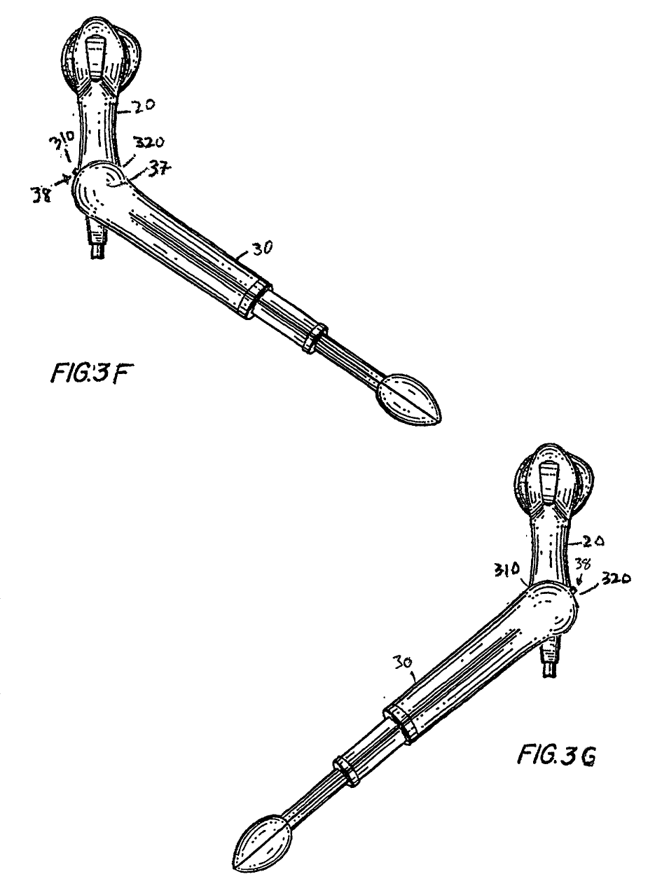

FIGS. 3A and 3E are views of the telescoping arm 30 in an extended position and retracted position, respectively. FIGS. 3B, 3C, and 3D show the telescoping arm at various intermediate extensions. It should be understood that the telescoping device may be expanded and retracted to a plurality of lengths, only some of which are shown. The telescoping arm 30 comprises a plurality of sliding members 31, 32 and 33 of graduated widths so that the sliding members 31, 32 and 33 fit substantially over one another when the telescoping arm 30 is in a contracted position as in FIG. 3E and substantially end on end when the arm 30 is in an extended position as in FIG. 3A. The distal end of the second sliding member 32 has an external rim 36 of a circumference greater than the internal opening of the first sliding member 31 to prevent the second sliding member 32 from retracting too far inside the first sliding member 31. A microphone 34 for the reception of audio signals is attached to the distal end of the third and innermost sliding member 33. The circumference of microphone 34 is greater than the internal opening of the second sliding member 32, thereby preventing the third sliding member 33 from retracting too far inside the second sliding member 32. The first and second sliding members 31 and 32 also contain internal stops (not shown) to prevent the second and third sliding members 32 and 33 from extending too far beyond the first and second sliding members 31 and 32, respectively.

As seen in FIG. 3A, the telescoping arm 30 is arcuate or curved inwards so as to bring the microphone closer to the user's mouth when the headset 10 is worn. In addition, the inward curvature of the telescoping arm 30 operates in conjunction with the support protrusion 24 of FIG. 1 to enhance the balance of the headset 10 against the user's head.

Referring to FIG. 3F, the telescoping arm 30 has a raised portion or edge 38 at the microphone pivot end 37. As seen in FIGS. 3F and 3G, the raised edge 38 of the telescoping arm 30 prevents the telescoping arm from being pivoted beyond a first point 310 and a second point 320 of the earphone arm 20. This protects against the twisting of wires 81, 82, or 83 located within the headset 10 as described below in connection with FIG. 8.

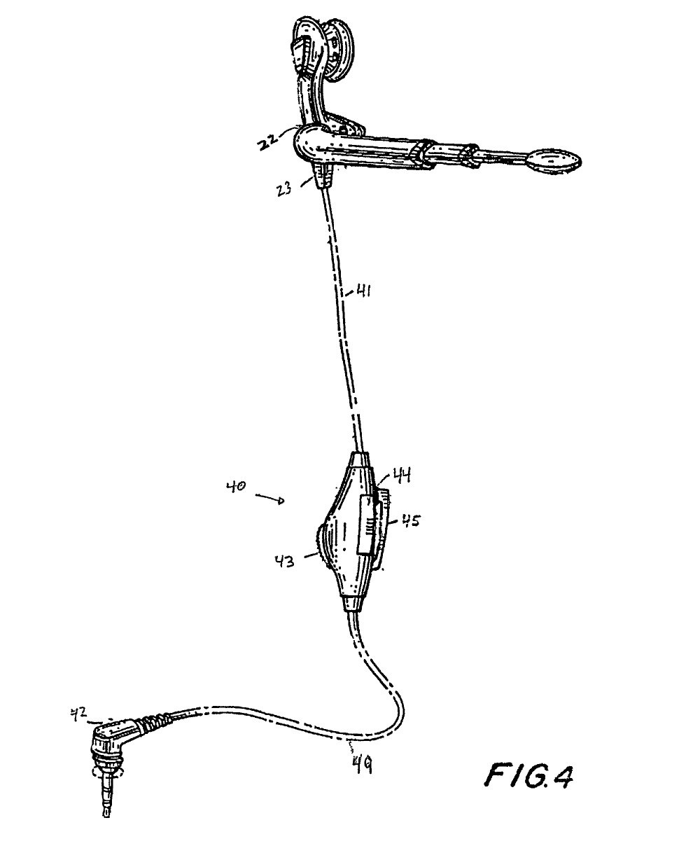

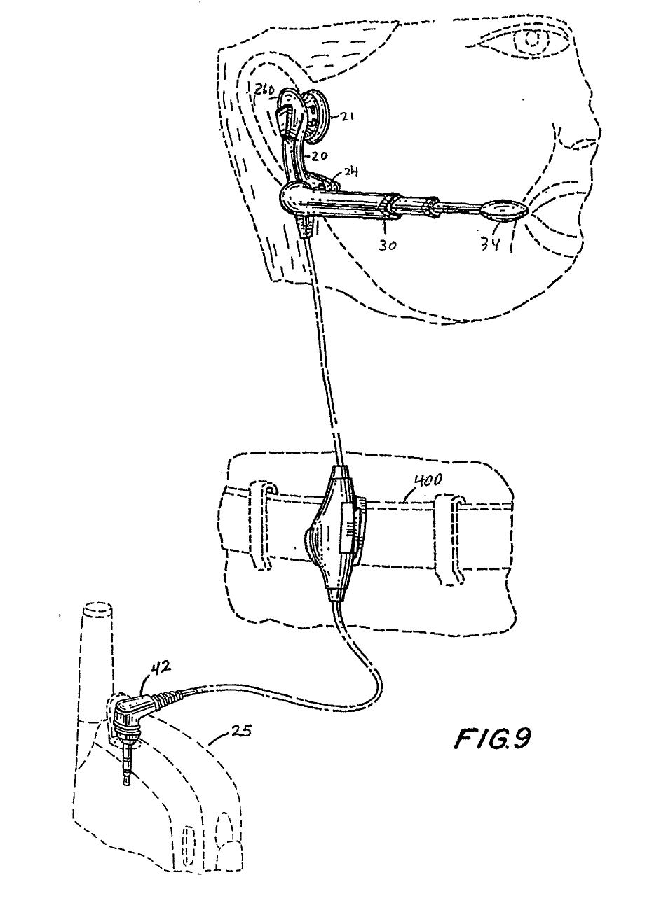

FIG. 4 shows the conventional remote control unit 40 of FIG. 1. Communication wires 41 extend from the communications lead 23 of the earphone arm pivot end 22 to the remote control unit 40. A second set of communication wires 49 extends from the remote control unit 40 to a conventional plug connector 42 which connects to a jack of a conventional cellular telephone (not shown). The remote control unit 40 comprises a conventional volume dial 43 and a conventional mute switch 44. The volume dial 43 is used to control the volume of the signals received through the earphone 21 from the cellular telephone. The mute switch 44 is used to temporarily disengage the transmission of audio signals from the microphone 34. A clip 45 extends from the remote control unit 40. The clip 45 is shaped to secure to an item of the user such a belt buckle 400 as shown in FIG. 9.

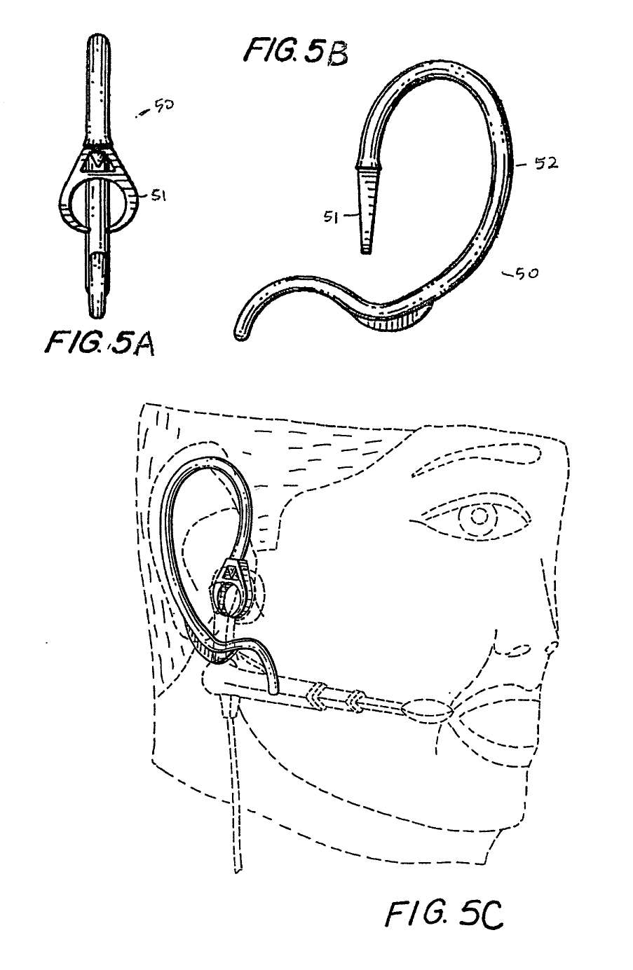

FIGS. 5A and 5B show an embodiment of an ear hook 50 in front view and side view, respectively. FIG. 5B shows the ear hook 50 of FIG. 5A and FIG. 5B attached to the headset 10 of FIG. 1. The ear hook 50 has a clamp 51 at one end. The clamp 51 is shaped to removably attach to the earphone arm 20 of headset 10. Preferably, clamp 51 is adapted to attach to the neck portion 250 located behind the earphone 21 as shown in FIG. 5C. The body 52 of the ear hook 50 is shaped to fit around an ear of the user.

FIG. 6A shows an embodiment of an eyeglass attachment and FIG. 6B shows the eyeglass attachment of FIG. 6A as attached to the headset 10 of FIG. 1, respectively. The eyeglass attachment 60 comprises a first portion 66 having a first portion pivot end 65 extending towards a loop 61 for looping around an arm 610 of a pair of eyeglasses worn by the user as shown in FIG. 6B. The size of the loop opening 62 is adjustable by sliding a sliding tube 63 along the first portion 66 towards and away from the first portion pivot end 65 of the eyeglass attachment 60. The second portion 67 of the eyeglass attachment 60 has a second pivot end 68 and an attachment end 69. The second portion pivot end 68 is pivotally connected to the first portion pivot end 65. The attachment end 69 of the second portion 67 is shaped to frictionally fit into the hole 26 of the earphone arm pivot end 22 of FIGS. 2A and 2C. The attachment end 69 of the eyeglass attachment 60 may be inserted into either the first side opening 27 or the second side opening 28 of the hole 26 of FIG. 2C, depending on which ear the headset 10 is being worn.

FIG. 7 shows a view of the headset 10 in a folded and retracted position. The telescoping arm 30 is in a retracted position as in FIG. 3E and the telescoping arm 30 is pivoted to substantially align with the earphone arm 20.

FIG. 8 shows a cross sectional view depicting the internal wiring of the headset 10 of FIG. 1. A receiver wire 81 is coupled to the earphone 21 and extends from the earphone 21 through the earphone arm 20, exiting the earphone arm 20 at the communications lead 23. A transmission wire 82 is coupled to the microphone 34 and extends through the telescoping arm 30, through the microphone arm pivot end 37 into the earphone arm pivot end 22, and exiting the earphone arm 20 at the communications lead 23. A control wire 83 is coupled to the button 29 on the earphone arm 20. The control wire 83 extends from the button 29 through the earphone arm 20 and is coupled to the transmission wire 82 extending from the microphone 34.

The receiver wire 81 and the transmission wire 82 extend together as communication wires 41 from the communications lead 23 to a remote control unit 40 of a conventional design. At a first end 48 of the remote control unit 40, the communication wires 41 are coupled to a printed circuit board (PCB) 84 that controls the volume and mute functions. A second set of communication wires 49 is coupled to the PCB 84 at a second end 47 of the remote control unit 40 and extends to a conventional plug connector 42 which connects to a jack of a conventional cellular telephone (not shown).

FIG. 9 shows a view of an embodiment of the invention being worn by a typical user. The earphone 21 is inserted into the ear of the user while the support protrusion 24 rests under the user's ear. The telescoping arm 30 is extended towards and pivoted in the direction of the mouth of the user.

In use, the conventional plug connector 42 is inserted into a cellular phone unit 25 as shown in FIG. 9. This conventionally disables the speaker and receiver of the cellular phone 25 and enables the speaker and receiver of the headset 10. The headset 10 is worn by inserting the earphone 21 into the ear of the user while the support protrusion 24 rests beneath the user's ear. The support protrusion 24 provides additional support and stabilization to the headset 10 in position against the head of the user. In addition the shoulder 260 of the earphone arm 20 assists in securing the earphone 21 in the user's ear and provides additional stabilization to the headset 10. The user adjusts the fit of the headset 10 by pivoting the telescoping arm 30 in relation to the earphone arm 20 and extending and retracting the telescoping arm 30. The user is thereby able to adjust the headset 10 to improve comfort as well as to adjust the position of the microphone 34 in relation to the user's mouth to optimize the quality of the transmitted audio signals. The user may also pivot the telescoping arm 30 in relation to the earphone arm 20 to wear the headset 10 on the opposite ear of the user. The arcuate shape of the telescoping arm 30 brings the microphone 34 closer to the mouth of the user and provides for a more secure fit of the headset 10 against the head of the user. When not using the microphone 34, the user may easily pivot the telescoping arm 30 away from the mouth of the user without removing the headset 10. The user may subsequently pivot the telescoping arm 30 back towards the mouth when use of the microphone 34 is resumed.

As shown in FIG. 5C, for added support the user may attach the ear hook 50 to the headset 10. The body 52 of the ear hook 50 is secured around the ear of the user and the clamp 51 of the ear hook 50 is attached to the neck portion 250 of the earphone arm 20.

As shown in FIG. 6B, as another option for additional support the user may attach the eyeglass attachment 60 to the headset 10 by inserting the attachment end 69 of the eyeglass attachment 60 into the hole 26 of the earphone arm pivot end 22. The loop 61 of the eyeglass attachment 60 is secured around an arm 610 of a pair of eyeglasses worn by the user. The size of the loop opening 62 is adjusted by sliding the sliding tube 63 towards and away from the first portion pivot end 65.

The previously described embodiments of the invention have many advantages, including hands-free use of a cellular phone and an adjustable headset fit for optimal comfort and audio sound quality. In addition, a stable fit is provided against the head of the user without the use of a bulky headband. The invention does not require all the advantageous features and all the advantages need to be incorporated into every embodiment of the invention.

Although the present invention has been described in considerable detail with reference to certain preferred embodiments thereof, other embodiments are possible. For example, the telescoping arm may have fewer or more sliding members than the preferred embodiment. Therefore, the spirit and scope of the appended claims should not be limited to the description of the preferred versions contained herein.

What is claimed is:

1. A headset adapted for use with a cellular telephone comprising:
an earphone for providing an auxiliary audio output for the cellular telephone;
an earphone arm which extends between the earphone and a pivot end;
a telescoping microphone arm which extends between a microphone and a microphone arm pivot end, the microphone arm pivot end being pivotally connected to the earphone arm pivot end, the microphone providing an auxiliary audio input for the cellular telephone, the telescoping microphone arm providing a plurality of adjustable positions for the microphone for variably locating the position of the microphone with respect to a mouth of a user of the cellular telephone when the headset is connected thereto; and
communication means for removably connecting the headset to the cellular telephone for receiving audio input signals through the cellular telephone to the earphone and sending audio output signals from the microphone through the cellular telephone.

2. The headset of claim 1, wherein the communication means further comprises remote disconnect means for remotely disconnecting the cellular telephone from receiving and sending audio signals.

3. The headset of claim 2, wherein the communication means further comprises muting means for muting the sending of audio signals.

4. The headset of claim 1, further comprising:
a receiver wire coupled to the earphone;
a transmitter wire coupled to the microphone; and
a control unit coupled to the receiver wire and the transmitter wire, wherein the control unit comprises a volume control dial and a mute switch.

5. The headset of claim 1 further comprising a push button integrated into the earphone arm, wherein the push button comprises means for remotely engaging or disconnecting a telephone call.

6. The headset of claim 1, wherein the microphone arm can be pivoted to substantially align with the earphone arm for compact storage.

7. The headset of claim 1, wherein the microphone arm can be pivoted in relation to the earphone arm so that the headset can be worn on either a left ear or a right ear of the user.

8. The headset of claim 1, further comprising a raised portion means located at the pivot end of the microphone arm to inhibit the microphone arm from rotating beyond a point where the raised portion comes into contact with the earphone arm.

9. The headset of claim 1, further comprising attachment means located at a first side and a second side of the pivot end of the earphone arm for securing an additional support means to either the first side or the second side.

10. The headset of claim 9, wherein the attachment means comprises a pass-through hole wherein the hole is sized to frictionally secure an attachment therein.

11. The headset of claim 1, wherein the microphone arm is an arcuate telescoping arm.

12. The headset of claim 1, further comprising a detachable ear hook means removably connected to the earphone arm and securable around an ear of the user for providing additional support to the headset in position against the user.

13. The headset of claim 1, further comprising a detachable eyeglass attachment having a first portion and a second portion, wherein the first portion of the eyeglass attachment comprises a loop means for securing around an arm of a pair of eyeglasses, wherein the second portion of the eyeglass attachment comprises a means for removably connecting to the earphone arm.

14. A headset for a cellular telephone comprising:
an earphone for providing an auxiliary audio output for the cellular telephone;
an earphone arm which extends between the earphone and a pivot end;
a support protrusion which extends from the earphone arm and rests under an ear of a user when the headset is connected to the user;
a telescoping microphone arm which extends between a microphone and a microphone arm pivot end, the microphone arm pivot end being pivotally connected to the earphone arm pivot end, the microphone providing an auxiliary audio input for the cellular telephone, the telescoping microphone arm providing a plurality of adjustable positions for the microphone for variably locating the position of the microphone with respect to a mouth of a user of the cellular telephone when the headset is connected thereto; and
communication means for removably connecting the headset to the cellular telephone for receiving audio input signals through the cellular telephone to the earphone and sending audio output signals from the microphone through the cellular telephone.

15. The headset of claim 14, wherein the protrusion is located at the pivot end of the earphone arm.

16. The headset of claim 14, wherein the earphone is shaped to fit into the ear of the user.

17. The headset of claim 14, wherein the earphone arm has a neck portion extending from behind the earphone and a shoulder portion located behind the neck portion, wherein the neck portion of the earphone arm fits over the tragus and anti-tragus portions of the ear when the earphone is fit into the ear of the user.

18. A headset for a cellular telephone comprising:
an earphone for providing an auxiliary audio output for the cellular telephone, wherein the earphone is shaped to fit into an ear of a user;
an earphone arm which extends between the earphone and a pivot end, wherein the earphone arm has a neck portion extending from behind the earphone and a shoulder portion located behind the neck portion, wherein the neck portion of the earphone arm fits over the tragus and anti-tragus portions of the ear when the earphone is fit into the ear of the user;
a support protrusion which extends from the earphone arm and rests under the ear of the user when the headset is connected to the user;
a microphone arm which extends between a microphone and a microphone arm pivot end, the microphone arm pivot end being pivotally connected to the earphone arm pivot end; and
communication means for removably connecting the headset to the cellular telephone for receiving audio input signals through the cellular telephone to the earphone and sending audio output signals from the microphone through the cellular telephone.
